(19) United States
(12) Patent Application Publication
(10) Pub. No.: US 2013/0088438 A1
(43) Pub. Date: Apr. 11, 2013

(54) METHOD AND ELECTRONIC DEVICE FOR HAPTIC/TACTILE FEEDBACK

(71) Applicants: Yu-Liang Shih, Changhua County (TW); Jung-Wen Chang, Tao Yuan Shien (TW); Ya-Chun Hsu, Bade City (TW); Yi-Pin Huang, Guishan Township (TW)

(72) Inventors: Yu-Liang Shih, Changhua County (TW); Jung-Wen Chang, Tao Yuan Shien (TW); Ya-Chun Hsu, Bade City (TW); Yi-Pin Huang, Guishan Township (TW)

(73) Assignee: Quanta Computer Inc., Tao Yuan Shien (TW)

(21) Appl. No.: 13/412,671

(22) Filed: Mar. 6, 2012

(30) Foreign Application Priority Data
Oct. 5, 2011 (TW) 100136175

(51) Int. Cl. G06F 3/041

(52) U.S. Cl. 345/173

(57) ABSTRACT

A method and an electronic device for tactile feedback are provided. The method includes: controlling a display panel to display an electronic book; controlling a haptic/tactile actuator to generate haptic/tactile feedback to express a texture of paper of the electronic book; detecting a drag input on a touch panel when the electronic book is displayed, the drag input including a plurality of touch points for page flipping of the electronic book; and controlling the haptic/tactile actuator to adjust the strength of the haptic/tactile feedback to express page flipping of the electronic book.

This application claims the benefit of Taiwan application Serial No. 100136175, filed Oct. 5, 2011, the subject matter of which is incorporated herein by reference.

### TECHNICAL FIELD

The disclosure relates in general to a method and an electronic device for haptic/tactile feedback, and more particularly to a method and an electronic device for haptic/tactile feedback for an electronic book.

### BACKGROUND

Contributed by technology developments, a prevalent current information interface is switched from conventional paper books to digital books. In response to the trend of digital books, publishers continuously launch services of electronic books to satisfy user needs.

Services of electronic books are, for example, a reader interface that displays an electronic book on a touch display provided on a mobile device such as a tablet computer. Through the interface, a user flips pages of an electronic book via a touch input such as dragging.

However, a common touch display is incapable of providing apparent haptic/tactile feedback. For example, when a user performs a touch input, a sense of contact may not be apparently received by a fingertip or a control pen, such that it is possible that a user is not completely certain whether a desired touch input is completed or may even be unaware of the number of times of actual contacts. That is to say, the touch display fails in rendering physical, concrete sense of touching an electronic book to the user via a surface of a display screen. Therefore, an electronic device equipped with a touch display often informs a user of an outcome of a touch via visual feedback given through a change in the display screen. Yet, such approach not only provides limited tactile feedback but also imposes visual loading on the user to depreciate operation conveniences of the electronic device.

### SUMMARY OF THE DISCLOSURE

The disclosure is directed to a method and an electronic device for haptic/tactile feedback. In the method and the electronic device for haptic/tactile feedback, a haptic/tactile actuator is utilized to generate haptic/tactile feedback to allow a user to feel a texture or weight of paper of an electronic book displayed on a surface of a touch panel, as well as to create a sense of simulated touching a real object of page flipping of the electronic book, thereby optimizing operation conveniences of the electronic device.

According to an example of the present disclosure, a method for haptic/tactile feedback is provided. The method includes: controlling a display panel to display an electronic book; controlling a haptic/tactile actuator to generate haptic/tactile feedback to express the texture of paper of the electronic book; detecting a drag input on a touch panel when the electronic book is displayed, the drag input comprising a plurality of touch points for page flipping of the electronic book; and controlling the haptic/tactile actuator to adjust the strength of the haptic/tactile feedback to express page flipping of the electronic book.

According to another example of the present disclosure, an electronic device for haptic/tactile feedback is provided. The electronic device includes a processing module, a display panel, a touch panel and a haptic/tactile actuator. The display panel is coupled to the processing module. The touch panel is coupled to the processing module, and is also coupled to the display panel to form a touch display. The haptic/tactile actuator is coupled to the processing module. The processing module controls the display panel to display an electronic book, and controls the haptic/tactile actuator to generate haptic/tactile feedback to express paper texture of the electronic book. The processing module further detects a drag input on the touch panel when the electronic book is displayed, the drag input comprising a plurality of touch points for flipping a page of the electronic book. In response to positions of the touch points, the processing module further controls the haptic/tactile actuator to adjust the strength of haptic/tactile feedback to express page flipping of the electronic book.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 is a flowchart of a method for haptic/tactile feedback according to an embodiment of the present disclosure.

FIG. 2 is a block diagram of an electronic device according to an embodiment of the present disclosure.

FIG. 3A is a schematic diagram of an example of an electronic book display by the electronic device in FIG. 2.

FIG. 3B is an enlarged schematic diagram of a region L of the electronic book in FIG. 3A.

FIG. 4A is a schematic diagram of an example of region division of the electronic book in FIG. 3A.

FIG. 4B is an example of a relationship curve of the regions of the electronic book in FIG. 4A and the strength of haptic/tactile feedback.

### DETAILED DESCRIPTION OF THE DISCLOSURE

A method and an electronic device for haptic/tactile feedback according to an embodiment of the present disclosure shall be described below. In some embodiments, by providing haptic/tactile feedback, a user is allowed to feel the texture or weight of paper of an electronic book displayed on a surface of a touch panel, as well as to create a sense of simulated touching a real object when page flipping of the electronic book performed, thereby optimizing operation conveniences of the electronic book.

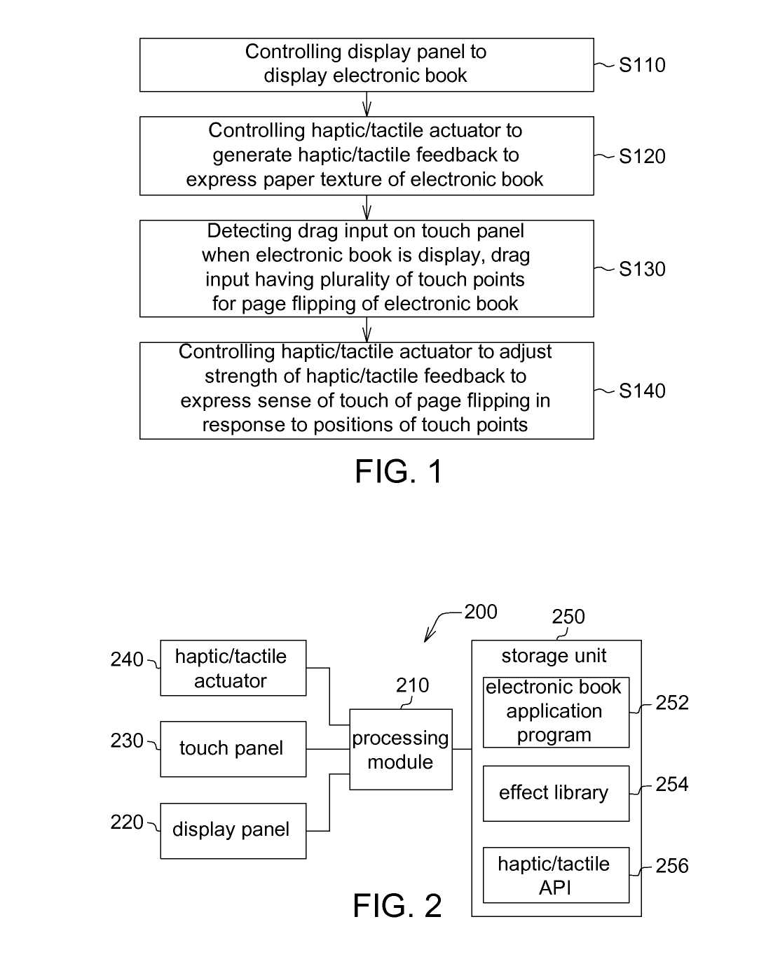

FIG. 1 shows a flowchart of a method for haptic/tactile feedback according to an embodiment of the present disclosure. The method includes a number of steps. Step S110 includes controlling a display panel to display an electronic book. Step S120 includes controlling a haptic/tactile actuator to generate haptic/tactile feedback to express the paper texture of the electronic book. Step S130 includes detecting a drag input on a touch panel when the electronic book is displayed. Step S140 includes controlling the haptic/tactile actuator to adjust the strength of haptic/tactile feedback to express a sense of touching for page flipping of the electronic book in response to positions of the touch points.

The haptic/tactile feedback allows a user to feel the texture and weight of paper of the electronic book at a surface of the touch panel. As the drag input is completed, the haptic/tactile actuator adjusts the strength of haptic/tactile feedback to express a sense of simulated touching a real object when page flipping of the electronic book is performed, so as to optimize operation conveniences of the electronic book. Further, by providing haptic/tactile feedback, reliance on visual feedback for a user is reduced while enhancing user experiences.

FIG. 2 shows a block diagram of an electronic device according to an embodiment of the present disclosure. For example, an electronic device 200 is an electronic book reader, or other electronic devices such as a tablet computer, a handheld device or a smart phone offering electronic book services. In this embodiment, the electronic device 200 includes a processing module 210, a display panel 220, a touch panel 230, a haptic/tactile actuator 240 and a storage unit 250.

The processing module 210 performs various computation procedures, and includes a micro processing chip or other processors with computation capabilities. The processing module 210, operatively coupled to the display panel 220, the touch panel 230, the haptic/tactile actuator 240 and the storage unit 250, detects a touch received by the touch panel 230 and correspondingly controls display information on the display panel 220 to provide visual feedback. The processing module 210 further detects a touch received by the touch panel 230 to correspondingly drive the haptic/tactile actuator 240 to generate haptic/tactile feedback.

The display panel 220 displays various types of information. For example, the display panel 220 is an electronic paper (ePaper) display panel, an electrophoretic ink (E-Ink) display panel, a light-emitting diode (LED) liquid crystal display panel, an organic light-emitting diode (OLED) display panel, or an active matrix organic light-emitting diode (AMOLED) display panel. In other possible embodiments, the display panel 220 may also be integrated with the touch panel 230 to form a super AMOLED display panel. It should be noted that the display panel 220 is not limited to the examples above, but may be other equivalent devices offering visual feedback.

For example, the touch panel 230 is a resistive, capacitive, optic or ultrasonic touch panel, or other types of touch panel. A touch region of the touch panel 230 corresponds to a display region of the display panel 220 to realize visual feedback. For example, the touch panel 230 is covered on the display panel 220 or is embedded into the display panel 220. The touch panel 230 is further coupled to the display panel 220 to form a touch display.

The actuator 240 generates haptic/tactile feedback. For example, the haptic/tactile actuator 240 is based on a piezoelectric vibrator, a vibrating motor, a heat-generating actuator, or an eccentric rotating mass (ERM) actuator, to generate vibration feedback, vibrotactile feedback, or heat-energy feedback. It should be noted that other types of haptic/tactile feedback may be rendered according to haptic/tactile feedback in different forms. In practice, haptic/tactile feedback provided by the haptic/tactile actuator 240 may be utilized for simulating the feel of grains of a texture of different levels, e.g., a fine to coarse texture, or a sharp to smooth texture.

The storage unit 250 stores various kinds of system software and information. For example, the storage unit 250 stores an electronic book application program 252, an effect library 254, a haptic/tactile application programming interface (API) 256, and/or other control software. The electronic book application program 252 provides a reader or browser interface for the electronic book. The effect library 254, also referred to as a tactile effect library, is a library containing tactile feedback information converted from different tactile effects. The effect library 254 compiles and codes information to construct or simulate respective tactile feedback, e.g., simulating tactile feedback of the paper texture of the electronic book. The haptic/tactile API 256 is applied in the electronic book application program 252 to retrieve desired tactile effects from the effect library 254.

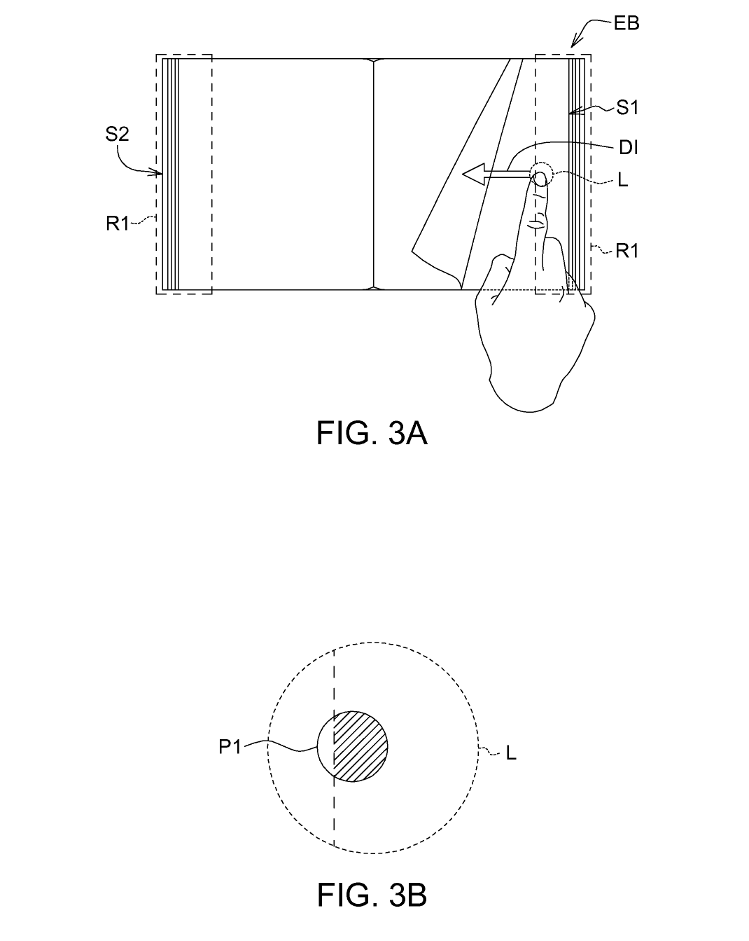

FIG. 3A shows a schematic diagram of an example of an electronic book display by the electronic device in FIG. 2; and FIG. 3B shows an enlarged schematic diagram of a region L of the electronic book in FIG. 3A. Also referring to FIGS. 1, 2, 3A and 3B, the flowchart in FIG. 1 shall be described in detail by taking the electronic book in FIG. 3A as an example with reference to the electronic device in FIG. 2.

In Step S110, the processing module 210 controls the display panel 220 to display the electronic book. For example, an electronic book EB in FIG. 3A is a substitute of a conventional paper book, and may be read by an additional electronic reading device, e.g., a personal computer, an electronic book reader, or an electronic dictionary.

In some embodiments, the electronic book is displayed with a double-page browsing mode. For example, as shown in FIG. 3A, the electronic device 200 provides a double-page browsing mode to display the electronic book EB allowing full-book and cross-page browsing. In other embodiments, the electronic device 200 may also provide other browsing modes such as a single-page browsing mode allowing a user to read content of one page of the electronic book at a time.

In Step S120, the processing module 210 controls the haptic/tactile actuator 240 to generate haptic/tactile feedback to express the paper texture of the electronic book. For example, as shown in FIG. 3A, the paper texture of the electronic book EB is a paper texture from fine to coarse or from sharp to smooth.

In some embodiments, in order to express the paper texture of the electronic book EB, the haptic/tactile actuator 240 may generate various types of user-programmable waveforms, including sinusoidal waves, trapezoidal waves, square waves or pulse waves. The haptic/tactile actuator 240 may be utilized to drive a piezoelectric load, for example, to obtain a user-defined tactile feel.

In other embodiments, the haptic/tactile actuator 240 may utilize different strength intensities of haptic/tactile feedback to express the paper texture of the electronic book. For example, haptic/tactile feedback in a high intense strength may be utilized to express a coarse or sharp paper texture, and haptic/tactile feedback in a weak intense strength may be utilized to express a fine or smooth paper texture.

An example for illustrating how a paper texture is expressed by the strength of haptic/tactile feedback shall be given below.

TABLE 1

| Type of paper | Coarse value | Index value |
|---|---|---|
| Coated paper | 5 | 1 |
| Photographic paper | 10 | 2 |
| Pictorial paper | 15 | 3 |
| Magazine paper | 20 | 4 |
| Photocopy paper | 25 | 5 |
| Tissue paper | 30 | 6 |
| Chinese calligraphy | 35 | 7 |
| paper | | |
| Wood-free paper | 50 | 8 |

Table-1 contains columns for index values and coarse values. The coarse value is defined as: the coarseness of paper is smaller if paper is more similar to the coated paper, and the coarseness of paper is larger if paper gets more similar to the wood-free paper. That is, the coated paper is the finest and the wood-free paper is the coarsest. The strength of haptic/tactile feedback gets more intense as the coarse value gets larger to reflect the level of coarseness. The index value represents the coarseness of different types of paper. The relationship between the coarse value and the index value is stored in the effect library 254 for future look-up or search.

In Step S130, the processing module 210 detects a drag input on the touch panel 230 when the electronic book is displayed. For example, as shown in FIG. 3A, a drag input DI may include a plurality of touch points resulted from a user finger touching and remaining in contact with the touch panel 230 and then dragging or sliding along a certain direction.

In some embodiments, the processing module 210 determines whether the drag input DI is for page flipping of the electronic book according to positions of the touch points of the drag input DI. More specifically, since the page flipping or page changing of a book is generally performed by a user touch starting at one side of a page and moving towards an opposite side, a predetermined range R1 indicative of a page flipping area may be in advance defined at an edge of a page. With such definition, the processing module 210 first determines whether the touch point is established or valid according to a minimum area and then determines whether the position of the touch point falls within the page flipping area, so as to determine whether the user intends to flip page. When an overlap between a contact area of the touch point and the page flipping area on the touch panel 230 is enough, it is determined that the user intends to flip page, i.e., it is determined that the drag input is intended for page flipping.

For example, as shown in FIG. 3A, the processing module 210 calculates a contact area resulted from a touch point PI of the drag input DI on the touch panel 230, and further calculates an overlap ratio between the contact area and a predetermined range R1 near a side S1 of the electronic book EB on the touch panel 230. The predetermined range R1 represents a page flipping area having a width of, e.g., 10% of a total width of the touch panel 230. For example, the overlap ratio is a ratio between the contact area and an overlapping area (indicated by a shaded area) of the contact area falling within the predetermined range R1. The processing module 210 further determines the drag input DI is intended for page flipping of the electronic book EB when the contact area is larger than a threshold and the overlap ratio is greater than a predetermined ratio. For example, when a total area of the contact area is larger than 0.5 cm² and the overlap ratio is greater than 70%, it is determined the drag input DI is intended for page flipping of the electronic book EB.

In Step S140, in response to the positions of the touch points, the processing module 210 controls the haptic/tactile actuator 240 to adjust the strength of the haptic/tactile feedback to express a sense of touch of flipping the page of the electronic book.

From perspectives of flipping a page of a conventional paper book, the sense of touch upon a user finger is more intense when an edge of a page of the book is initially touched and gradually diminishes along the process of page flipping. To express such sense of touch of page flipping, the strength of haptic/tactile feedback may gradually reduce as the position of a current touch point changes.

Taking FIG. 3A as an example, for the electronic book EB in a double-page browsing mode, the strength of haptic/tactile feedback is more intense at two sides S1 and S2 and weaker in the middle of the electronic book EB. Thus, the strength of haptic/tactile feedback reduces gradually as the position of a current touch point gets farther away from the side S1 to accurately express the sense of touch of page flipping of the electronic book.

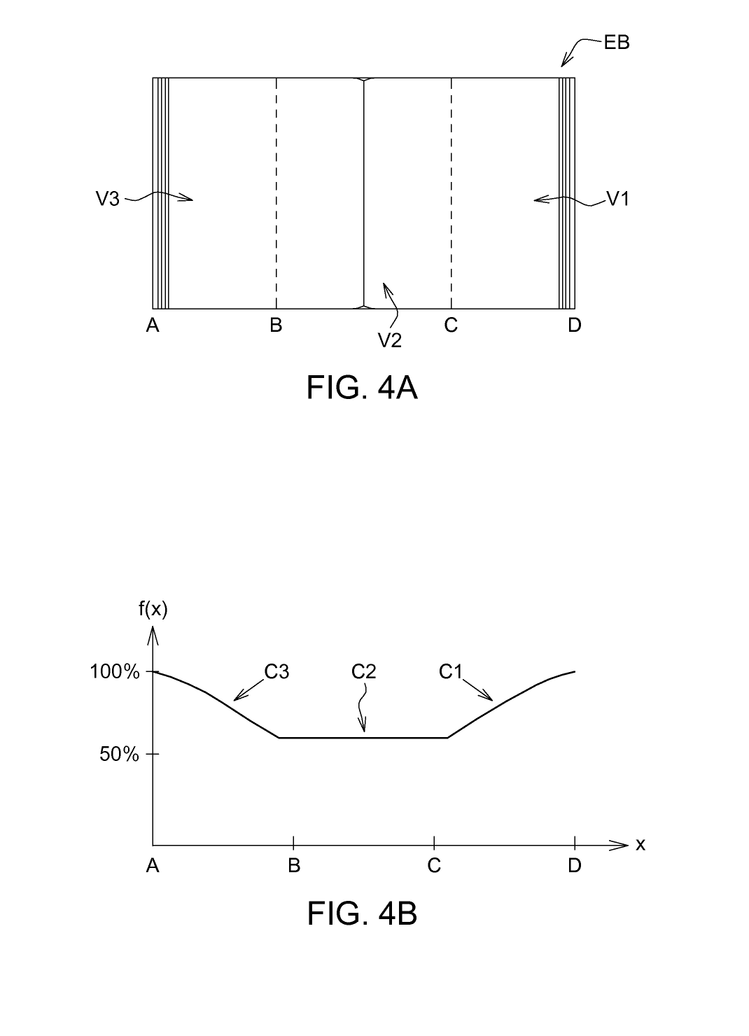

An example for illustrating how the strength of haptic/tactile feedback is adjusted shall be given below. FIG. 4A shows a schematic diagram of an example of region division of the electronic book in FIG. 3A. FIG. 4B shows an example of a relationship curve of the regions of the electronic book in FIG. 4A and the strength of haptic/tactile feedback. In the example shown in FIG. 4A, between the sides S1 and S2 of the electronic book EB are a plurality of regions, e.g., V1 to V3, and different approaches are used for adjusting the strength of haptic/tactile feedback in the regions.

Referring to FIG. 4A, when the drag input DI reaches the region V1 of the electronic book EB, a current touch point falls within the region V1 of the electronic book EB. In response to the touch point currently falling within the region V1 of the electronic book EB, the processing module 210 controls the haptic/tactile actuator 240 to reduce the strength of haptic/tactile feedback. Referring to FIG. 4B, supposing a zero point of the vertical axis starts from the side S1 of the electronic book EB, for example, a curve C1 representing the relationship between a vertical position x in the region V1 (within an interval CD) and the strength f(x) of haptic/tactile feedback is f(x)=cos x.

Referring to FIG. 4A, when the drag input DI reaches the region V2 of the electronic book EB, the current touch point falls within the region V2 of the electronic book EB. In response to the touch point current falling within the region V2 of the electronic book EB, the processing module 210 controls the haptic/tactile actuator 240 to stop reducing the strength of haptic/tactile feedback. Referring to FIG. 4B, supposing the zero point of the vertical axis starts from the side S1 of the electronic book EB, for example, a curve C2 representing the relationship between a vertical position x in the region V2 (within an interval BC) and the strength f(x) of haptic/tactile feedback is f(x)=k, where k is a constant between 0 and 1.

Referring to FIG. 4A, when the drag input DI reaches the region V3 of the electronic book EB, the current touch point falls within the region V3 of the electronic book EB. In response to the touch point current falling within the region V3 of the electronic book EB, the processing module 210 controls the haptic/tactile actuator 240 to increase the strength of haptic/tactile feedback. Referring to FIG. 4B, supposing the zero point of the vertical axis starts from the side S1 of the electronic book EB, for example, a curve C3 representing the relationship between a vertical position x in the region V3 (within an interval AB) and the strength f(x) of haptic/tactile feedback is f(x)=1/cos x.

Cosine functions are taken as examples in the above relationship curves C1 and C3 rather than limiting the present disclosure thereto. In practice, other linear or non-linear functions, or user-defined functions may be adopted to realize the curve between the vertical position x and the strength of haptic/tactile feedback.

In some embodiments, the strength of haptic/tactile feedback generated by the actuator 240 may change along with a drag speed of the drag input. For example, the strength of haptic/tactile feedback generated by the haptic/tactile actuator 240 may increase as the drag speed of the drag input increases, or reduces as the drag speed of the drag input decreases. Thus, in response to a high-speed drag input, the haptic/tactile actuator 240 generates haptic/tactile feedback in an intense strength to increase the realness in the sense of touch of the electronic book.

In some embodiments, the processing module 210 may control the haptic/tactile actuator 240 to generate haptic/tactile feedback based on a function below:

Z=((Zmax*Pr/100)+Zf*S) Function (A)

In Function (A), Z represents a strength of haptic/tactile feedback, Zmax represents a maximum value among Z, Pr represents the paper texture of the electronic book, Zf represents the strength of haptic/tactile feedback when the drag input reaches the opposite side and falls within a predetermined region of the touch panel, and S represents the drag speed of the drag input.

As deduced from Function (A), the processing module 210 may determine the output parameter Z according to the three input parameters, Pr, Zf and S. For example, the output parameter Z is input to the haptic/tactile API 256 and reflected in the strength of haptic/tactile feedback. The input parameter Pr may be identified from the coarse value column in Table-1, the input parameter Zr may be determined according to the relationship curve in FIG. 4B, and the input parameter S may be calculated from a time difference and a distance between at least two touch points of the drag input.

Accordingly, the strength of haptic/tactile feedback may be adjusted through the input parameter Pr to express the feel of a paper texture of an electronic book. The strength of haptic/tactile feedback may be adjusted through the input parameter Zf to express the sense of touch of page flipping of an electronic book. The strength of haptic/tactile feedback may be adjusted through the input parameter S to enhance the realness in the sense of touch of an electronic book.

In some embodiments, Function (A) may be modified as:

Z=min(Zmax,((Zmax*Pr/100)+Zf*S)) Function (B)

In Function (B), min(a, b) respectively represent a minimum of a and b, so that the value of Z calculated from Function (B) is limited by the maximum value Zmax. Any values of Z exceeding the maximum value Zmax are substituted by Zmax.

In the description above, the drag input for page flipping is illustrated as an example. When the drag input DI is not intended for page flipping of an electronic book, it may imply that the positions of touch points of the drag input DI do not fall within the page flipping area or do not meet operation requirements related to the page flipping area. At this point, the processing module 210 retrieves corresponding texture information from the effect library 254, e.g., the coarse value (values of strength of haptic/tactile feedback) listed in Table-1, based on the index value of paper texture, and generates tactile feedback through the haptic/tactile actuator 240, so that a user feels the texture or weight of paper of the electronic book at the surface of the touch panel.

Therefore, in the method and the electronic device for haptic/tactile feedback, a haptic/tactile actuator is utilized to generate haptic/tactile feedback so that the user feels the texture or weight of paper of an electronic book displayed on a surface of a touch panel, as well as to simulate a sense of touching a real object for page flipping of the electronic book, thereby optimizing operation conveniences of the electronic device.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A method for haptic/tactile feedback, comprising:
controlling a display panel to display an electronic book;
controlling a haptic/tactile actuator to generate haptic/tactile feedback to express a texture of paper of the electronic book;
detecting a drag input on a touch panel when the electronic book is displayed, the drag input comprising a plurality of touch points for page flipping of the electronic book; and
controlling the haptic/tactile actuator to adjust a strength of the haptic/tactile feedback to express page flipping of the electronic book in response to positions of the touch points.

2. The method according to claim 1, wherein the step of adjusting the strength of haptic/tactile feedback includes:
controlling the haptic/tactile actuator to reduce the strength of haptic/tactile feedback in response to a touch point falling within a first region of the electronic book.

3. The method according to claim 2, wherein the step of adjusting the strength of haptic/tactile feedback, after the step of reducing the strength of haptic/tactile feedback, further includes:
controlling the haptic/tactile actuator to stop reducing the strength of haptic/tactile feedback in response to a touch point falling within a second region of the electronic book.

4. The method according to claim 3, wherein the step of adjusting the strength of haptic/tactile feedback, after the step of stop reducing the strength of haptic/tactile feedback, further includes:
controlling the haptic/tactile actuator to increase the strength of haptic/tactile feedback in response to a touch point falling within a third region of the electronic book.

5. The method according to claim 1, wherein the strength of haptic/tactile feedback generated by the haptic/tactile actuator changes with a drag speed of the drag input.

6. The method according to claim 5, wherein the strength of haptic/tactile feedback generated by the haptic/tactile actuator increases as the drag speed of the drag input increases.

7. The method according to claim 1, further comprising:
calculating a contact area resulted from a touch point of the drag input on the touch panel;
calculating an overlap ratio of the contact area relative to a predetermined range near a side of the electronic book on the display panel; and
determining the drag input is for page flipping of the electronic book when the contact area is larger than a threshold and the overlap ratio is greater than a predetermined ratio.

8. The method according to claim 1, wherein the haptic/tactile feedback generated by the haptic/tactile actuator is based on a function:
Z=((Zmax*Pr/100)+Zf*S);
where Z represent the strength of haptic/tactile feedback, Zmax represents a maximum strength of haptic/tactile feedback, Pr represents the texture of paper of the electronic book, Zf represents the strength of haptic/tactile feedback determined by the positions of the touch points, and S represents a drag speed of the drag input.

9. An electronic device for haptic/tactile feedback, comprising:
a processing module;
a display panel, coupled to the processing module;
a touch panel, coupled to the processing module, and coupled to the display panel to form a touch display; and
a haptic/tactile actuator, coupled to the processing module;
wherein, the processing module controls the display panel to display an electronic book; controls the haptic/tactile actuator to generate haptic/tactile feedback to express a texture of paper of the electronic book; detects a drag input on the touch panel when the electronic book is displayed, the drag input comprising a plurality of touch points for page flipping of the electronic book; and controls the haptic/tactile actuator to adjust the strength of haptic/tactile feedback to express page flipping of the electronic book in response to positions of the touch points.

10. The electronic device according to claim 9, wherein the processing module controls the haptic/tactile actuator to reduce the strength of haptic/tactile feedback in response to a touch point falling within a first region of the electronic book.

11. The electronic device according to claim 10, wherein the processing module controls the haptic/tactile actuator to stop reducing the strength of haptic/tactile feedback in response to a touch point falling within a second region of the electronic book.

12. The electronic device according to claim 11, wherein the processing module controls the haptic/tactile actuator to increase the strength of haptic/tactile feedback in response to a touch point falling within a third region of the electronic book.

13. The electronic device according to claim 9, wherein the strength of haptic/tactile feedback generated by the haptic/tactile actuator changes with a drag speed of the drag input.

14. The electronic device according to claim 13, wherein the strength of haptic/tactile feedback generated by the haptic/tactile actuator increases as the drag speed of the drag input increases.

15. The electronic device according to claim 9, wherein the processing module calculates a contact area resulted from a touch point of the drag input on the touch panel, calculates an overlap ratio of the contact area relative to a predetermined range near a side of the electronic book on the display panel, and determines that the drag input is for page flipping of the electronic book when the contact area is larger than a threshold and the overlap ratio is greater than a predetermined ratio.

16. The electronic device according to claim 9, wherein the haptic/tactile feedback generated by the haptic/tactile actuator is based on a function:
Z=((Zmax*Pr/100)+Zf*S);
where Z represent the strength of haptic/tactile feedback, Zmax represents a maximum strength of haptic/tactile feedback, Pr represents the texture of paper of the electronic book, Zf represents the strength of haptic/tactile feedback determined by the positions of the touch points, and S represents a drag speed of the drag input.
